(19) United States
(12) Patent Application Publication
(10) Pub. No.: US 2003/0107271 A1
(43) Pub. Date: Jun. 12, 2003

(54) Notebook computer with a power generator

(75) Inventor: Kuei-Hsiung Chen, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: MITAC TECHNOLOGY CORP.

(21) Appl. No.: 10/214,660

(22) Filed: Aug. 7, 2002

(30) Foreign Application Priority Data
Dec. 11, 2001 (TW) 90221589

(51) Int. Cl. H02J 3/32

(52) U.S. Cl. 307/46; 307/48

(57) ABSTRACT

A notebook computer in which power is generated by either alternating current power supply or external force. The notebook computer has a computer mainframe, a display, a battery, a first A/D transforming device coupled to the computer mainframe for transforming the alternating current power supply to a first direct current voltage, a power generator having an external force transmission device for generating an induced voltage by external force, and a constant voltage regulator to generate a regulated voltage by regulating the first direct current voltage and the induced voltage. In the notebook computer, external force transmission device further provides a rotatable shaft and a crank disposed on the shaft for applying external force. Further, the power generator can be a DC generator or an AC generator with a second A/D transforming device.

### BACKGROUND OF THE INVENTION

1. Field of the Invention

The present invention relates to a notebook computer with a power generator, and particularly to a notebook computer in which power is generated by either alternating current power supply or external force, so that the notebook computer is operated and recharged with power generated by external force when no power supply is available.

2. Description of the Related Art

Conventionally, operating power is alternatively supplied to a notebook computer from a battery or from an external power supply, which is generally transformed from alternating current (AC) voltage to direct current (DC) voltage. While supplying the operating power of the notebook computer, the external power supply simultaneously charges the battery. In this case, if the external power supply is suspended, the notebook computer depends on the battery to supply the operating power. Generally, a full-charged battery is suited to supply power for 2.5 to 3 hours before it requires recharging. The conventional notebook computer with such a battery can be operated in short-term usage. When the battery is depleted, the user must replace it with another alternate battery or connect the external power supply to continue use.

However, there are situations in which a user needs to use the notebook computer for a long period of time without external power supply. For example, a traveler might get lost in the wilderness and need to search for an e-map of the region with the notebook computer; an ambulance corps might use the notebook computer to acquire the map of a disaster area where the electricity is cut off; and a military officer on the battlefield might use the notebook computer for assistance with tactical simulation or material deployment. In these cases, external power supply or additional batteries may not be available for the required operation of the notebook computer. Consequently, in order to keep the notebook computer from suspension, it is necessary for the notebook computer to have a substitute power resource when no external power supply or battery is available.

Generally, power transformed from mechanical energy is easier to obtain than other power generating resources. Specifically, it is desirable for a user to apply mechanical forces, such as manpower or animal force, for power generation required by the notebook computer.

### SUMMARY OF THE INVENTION

In view of this, the object of the present invention is to disclose a portable computer (such as a notebook computer) with a power generator. In the portable computer, power is generated by either alternating current power supply or external force.

The portable computer of the present invention has a computer mainframe; a first A/D transforming device coupled to the computer mainframe for transforming the alternating current power supply to a first direct current voltage; a power generator disposed in the computer mainframe, the power generator having an external force transmission device for generating induced voltage in the power generator by external force; and a constant voltage regulator disposed in the computer mainframe and coupled to the first A/D transforming device for regulating the first direct current voltage and the induced voltage through a regulation process and generating a regulated voltage for operation of the computer mainframe.

The portable computer of the present invention may further comprise a battery disposed in the computer mainframe and coupled to the constant voltage regulator for receiving and storing the regulated voltage in order to supply power for operation of the computer mainframe when the constant voltage regulator does not regularly generate the regulated voltage.

Further, the portable computer of the present invention may comprise a display electrically connected to the computer mainframe.

Further, the portable computer of the present invention may comprise a shaft rotatably disposed in external force transmission device, wherein the shaft has a crank for rotating the shaft by external force. The shaft may be further provided with a handle disposed or pivoted on one end of the crank for applying external force.

Further, the power generator may comprise a DC generator, or an AC generator and a second A/D transforming device coupled to the AC generator.

### BRIEF DESCRIPTION OF THE DRAWINGS

The present invention can be more fully understood by reading the subsequent detailed description in conjunction with the examples and references made to the accompanying drawings, wherein:

FIG. 1a is an assembled view showing an embodiment of a notebook computer with a power generator of the present invention;

FIG. 1b is a schematic view showing the internal components of the embodiment in FIG. 1a of the present invention;

FIG. 2 is a perspective view showing external force transmission device of the embodiment in FIG. 1a of the present invention; and

FIG. 3 is a schematic view showing the internal components of another embodiment of the notebook computer with a power generator of the present invention.

### DETAILED DESCRIPTION OF THE PREFERRED EMBODIMENT

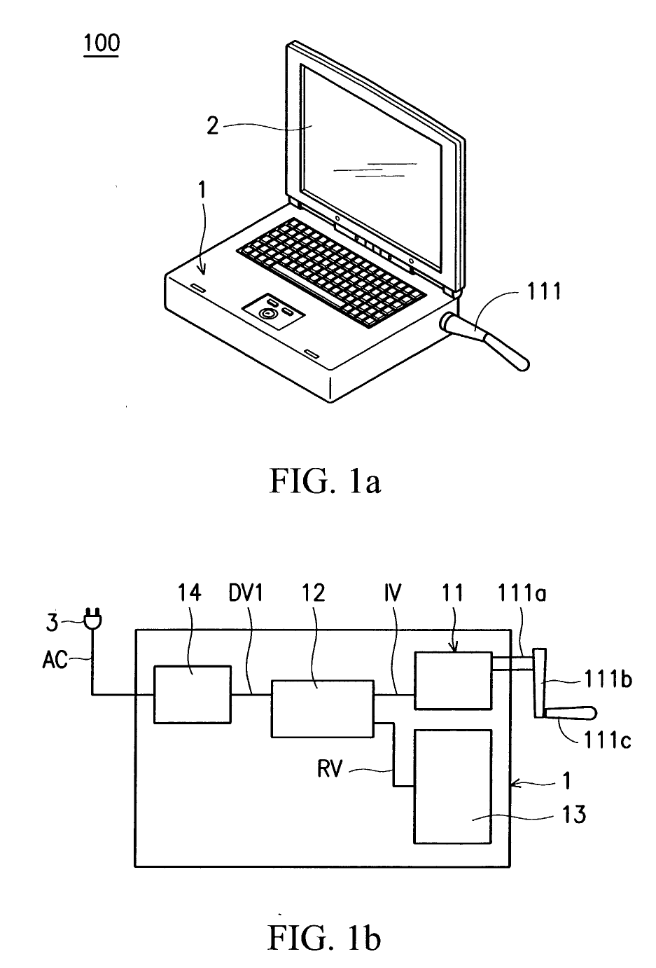

FIG. 1a shows an embodiment of the notebook computer 100 of the present invention. The notebook computer 100, which has a computer mainframe 1 and a display 2 electrically connected to the computer mainframe 1, is similar to conventional notebook computers in shape and size. However, the notebook computer 100 of the present invention has an external force transmission device 111.

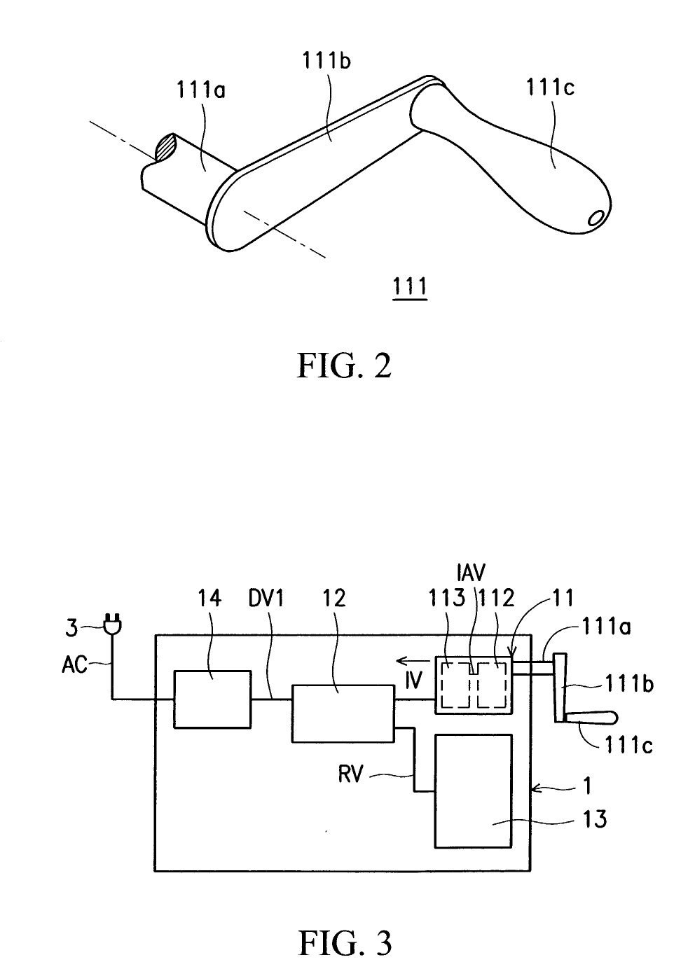

As shown in FIG. 1b, external force transmission device 111 imports mechanical energy to the power generator 11. Then, the power generator 11 transforms the mechanical energy to electrical voltage to provide the required power to the notebook computer 100. External force transmission device 111 is preferably provided with a shaft 111a, as shown in FIG. 2. In FIG. 2, the shaft 111a of the embodiment has a crank 111b, and a handle 111c is disposed on one end of the crank 111b. External force is applied on the handle 111c to rotate the shaft 111a. With the rotation of the shaft 111a, the mechanical energy is imparted by external force transmission device 111.

Further detailed description of the notebook computer 100 of the present invention is hereinafter disclosed referring to FIG. 1b. The notebook computer 100 is provided with two power supply method capabilities. One method is in the manner of typical AC power supply, which applies a plug 3 to be inserted to an AC power socket (not shown) to provide AC voltage to the notebook computer generator. The AC electric current (signal AC in FIG. 1b) flows to the first A/D transforming device 14, so that the AC voltage is transformed to a first DC voltage DV1. Then, a constant voltage regulator 12 transforms the first DC voltage DV1 to a regulated voltage RV in order to supply power for operation of the computer mainframe 1 of the notebook computer 100.

The other method requires application of the above-mentioned external force transmission device 111 and the power generator 11. In the embodiment shown in FIG. 1b, the power generator 11 is a rotary-type DC generator, which generates an induced voltage IV by the rotation of external force transmission device 111. The induced voltage IV is a DC voltage, which serves as a substitute for the first DC voltage DV1, so that the constant voltage regulator 12 transforms the induced voltage IV to the regulated voltage RV in order to supply power for operation of the computer mainframe 1 of the notebook computer 100.

FIG. 3 shows another embodiment of the present invention, in which the power generator 11 is an AC generator 112 and a second A/D transforming device 113. The AC generator 112 generates an induced AC voltage IAV by the rotation of external force transmission device 111; then, the second A/D transforming device 113 transforms the induced AC voltage IAV to a DC voltage as the induced voltage IV. In this embodiment, the induced voltage IV also serves as a substitute for the first DC voltage DV1, so that the constant voltage regulator 12 transforms the induced voltage IV to the regulated voltage RV in order to supply power for operation of the computer mainframe 1 of the notebook computer 100.

In the present invention, the constant voltage regulator is preferably the standard regulator of the notebook computer. Further, the first A/D transforming device 14 and the second A/D transforming device 113 are preferably the standard transformers of the notebook computer. Further, an external transformer can be applied as the first A/D transforming device 14 in order to reduce the size of the notebook computer.

Further, a battery 13 disposed in the computer mainframe 1 and coupled to the constant voltage regulator 12 is preferably applied in the notebook computer 100 of the present invention for receiving and storing the regulated voltage RV. In this case, the battery may supply power for operation of the computer mainframe 1 when the constant voltage regulator 12 does not regularly generate the regulated voltage RV. It is desirable to use a detachable battery, such as the conventional battery for the conventional notebook computer, as the battery 13.

Further, the shaft 111a of external force transmission device 111 may be connected to an external rotating device, such as a pedal roller, a windmill or a watermill, if any of these rotating devices is available.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A notebook computer in which power is generated by either alternating current power supply or external force, the notebook computer comprising:
a computer mainframe;
a display electrically connected to the computer mainframe;
a first A/D transforming device coupled to the computer mainframe, the first A/D transforming device transforming the alternating current power supply to a first direct current voltage;
a power generator disposed in the computer mainframe, the power generator having an external force transmission device for generating an induced voltage in the power generator by external force;
a constant voltage regulator disposed in the computer mainframe and coupled to the first A/D transforming device for regulating the first direct current voltage and the induced voltage through a regulation process and generating a regulated voltage for operation of the computer mainframe; and
a battery disposed in the computer mainframe and coupled to the constant voltage regulator for receiving and storing the regulated voltage in order to supply power for operation of the computer mainframe when the constant voltage regulator does not regularly generate the regulated voltage.

2. The notebook computer according to claim 1, further comprising a shaft rotatably disposed in external force transmission device, wherein the shaft has a crank for rotating the shaft by external force.

3. The notebook computer according to claim 1, further comprising a shaft rotatably disposed in external force transmission device, wherein the shaft has a crank for rotating the shaft by external force, with a handle disposed on one end of the crank for applying external force.

4. The notebook computer according to claim 1, further comprising a shaft rotatably disposed in external force transmission device, wherein the shaft has a crank for rotating the shaft by external force, with a handle pivoted on one end of the crank for applying external force.

5. The notebook computer according to claim 1, wherein the power generator comprises a DC generator.

6. The notebook computer according to claim 1, wherein the power generator comprises an AC generator and a second A/D transforming device coupled to the AC generator.

7. A portable computer in which power is generated by either alternating current power supply or external force, the portable computer comprising:
a computer mainframe;
a first A/D transforming device coupled to the computer mainframe, the first A/D transforming device transforming the alternating current power supply to a first direct current voltage;
a power generator disposed in the computer mainframe, the power generator having an external force transmission device for generating an induced voltage in the power generator by external force; and
a constant voltage regulator disposed in the computer mainframe and coupled to the first A/D transforming device for regulating the first direct current voltage and the induced voltage through a regulation process and generating a regulated voltage for operation of the computer mainframe.

8. The portable computer according to claim 7, further comprising a shaft rotatably disposed in external force transmission device, wherein the shaft has a crank for rotating the shaft by external force.

9. The portable computer according to claim 7, further comprising a shaft rotatably disposed in external force transmission device, wherein the shaft has a crank for rotating the shaft by external force, with a handle disposed on one end of the crank for applying external force.

10. The portable computer according to claim 7, further comprising a shaft rotatably disposed in external force transmission device, wherein the shaft has a crank for rotating the shaft by external force, with a handle pivoted on one end of the crank for applying external force.

11. The portable computer according to claim 7, further comprising a battery disposed in the computer mainframe and coupled to the constant voltage regulator to receive and store the regulated voltage in order to supply power for operation of the computer mainframe when the constant voltage regulator does not regularly generate the regulated voltage.

12. The portable computer according to claim 7, wherein the power generator comprises a DC generator.

13. The portable computer according to claim 7, wherein the power generator comprises an AC generator and a second A/D transforming device coupled to the AC generator.
